(19) United States
(12) Patent Application Publication
(10) Pub. No.: US 2011/0303111 A1
(43) Pub. Date: Dec. 15, 2011

(54) Stamping Apparatus

(76) Inventor: Terrence William Bolton, Surrey (GB)

(21) Appl. No.: 12/878,843

(22) Filed: Sep. 9, 2010

(30) Foreign Application Priority Data
Jun. 9, 2010 (GB) GB1009621.2

(51) Int. Cl. B41K 1/56

(52) U.S. Cl. 101/405

(57) ABSTRACT

A stamp for transferring a personalized colored image onto a selected surface includes a stamping surface and a flexible image bearing impermeable substrate of a polymer or copolymer having a textured surface. The stamp may be hand held and may include a handle at its end remote from the stamping surface. The substrate may be separable from and attachable to the stamping surface. One or a plurality of flexible image bearing impermeable substrates may be provided. The substrate material is preferably ethylene vinyl acetate.

### CROSS-REFERENCES TO RELATED APPLICATIONS

The present application claims priority from United Kingdom Application Serial Number GB1009621.2 filed on Jun. 9, 2010, which is hereby incorporated herein by reference in its entirety.

### TECHNICAL FIELD

This invention relates to stamping apparatus for transferring personalized colored images onto a selected surface. More especially, the invention relates to hand held stamping apparatus for transferring personalized colored images onto a selected surface.

### BACKGROUND OF THE INVENTION

Hand held stamps for transferring an inked image to a sheet of paper or some other medium are well known. Such stamps generally include a stamping surface of rubber or like material which is wetted through contact with an ink pad. The ink may permeate into the stamping surface which remains wet for a limited amount of time.

The image transferred by any given known stamp is generally fixed which means that a multiplicity of different stamps is required for use to convey different images. Stamps which enable the image to be varied within set limitations are known, such as date stamps.

To the best of the Applicant's knowledge, however, no stamps are currently available by which the user can create his or her personalized image for transfer to, for example, a sheet of drawing paper. Such a stamp would be especially appealing to children but only if it is relatively simple and clean to use and is capable of giving free range to the child's ability to create colored images for transfer to a sheet of paper or the like.

It is an objective of this invention to provide such a stamp.

### BRIEF SUMMARY OF EMBODIMENTS OF THE INVENTION

In one aspect this invention comprises stamping apparatus for transferring a personalized colored image onto a selected surface, the apparatus comprising a stamp including a stamping surface and a flexible image bearing impermeable substrate of a polymer or copolymer having a textured surface.

Preferably, the substrate is separable from but attachable to the stamping surface. Alternatively, the substrate may be permanently attached to the stamping surface.

The stamp may be hand held and may include at one end a handle. The stamping surface typically comprises an exposed surface of a stamping block positioned at the end of the stamp remote from the handle.

In another aspect the invention provides a coloring set comprising a stamp including a stamping surface, a flexible image bearing impermeable substrate of a polymer or copolymer formed with a textured surface for selective or permanent attachment to the stamping surface, and a source for applying liquid colorant onto that textured surface of the substrate which will be exposed when the substrate is attached to the stamping surface.

Preferably the stamp is hand held. A handle for the stamp may be provided. Alternatively, the stamp may be shaped to enable it to be gripped when it is applied to an image receiving surface. In one arrangement the stamp comprises a shaped body which may include a removable lid to enable the body to retain substrates not in use.

Preferably the substrate comprises ethylene vinyl acetate (EVA).

The substrate may comprise a flat sheet in the shape of a rectangle, square, circle, ellipse or other regular or irregular shape. Also, the substrate may be one of a set of such substrates of the same or different shapes. The set may comprise a plurality of individual substrates or, for example, a sheet holding a plurality of substrates each removable from the sheet through perforations or the like.

In one arrangement, one surface of each substrate is coated at least partially with an adhesive to enable it to be secured to the exposed stamping surface. The adhesive may take the form of an adhesive pad covered by a removable mask. Alternatively each substrate may have one or more pieces of Velcro (registered trade mark) which cooperate with a similar piece or pieces of Velcro attached to the stamping surface. Other known means of attachment may be employed.

The exposed stamping surface may be flat, curvilinear or circular. Other shaped stamping surfaces may be used.

The surface of the, one, some or each substrate may be scored or otherwise indented. Alternatively, or additionally, the surface of the, one some or each substrate may be ridged.

The source of colorant may comprise a fibrous tipped marker pen, a paint brush or other known applicator.

A coloring set in accordance with the invention may comprise a stamp having a stamping surface, a plurality of substrates as described in the preceding eleven paragraphs, and a plurality of marker pens. The coloring set may also include a plurality of stencils. The stamp may be hand held.

In a further aspect the invention comprises a flexible image bearing impermeable substrate formed with a textured surface for attachment to a stamping surface of a stamp, the substrate comprising ethylene vinyl acetate. The stamp may be hand held.

In a still further aspect, the invention comprises a stamp whose image transferring surface comprises an impermeable flexible substrate of a polymer or copolymer material having a textured surface such as ethylene vinyl acetate.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a side view in of a hand-held stamping apparatus in accordance with the invention;

FIG. 2 is a view from above of a substrate of stamping apparatus in accordance with the invention;

FIG. 3 is a side view of an alternative stamping apparatus in accordance with the invention;

FIG. 4 is a plan view of a substrate for use with the stamping apparatus shown in FIG. 3; and

FIGS. 5 to 7 are side views of alternative embodiments of the invention in which the stamping apparatus forms part of a marker pen.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

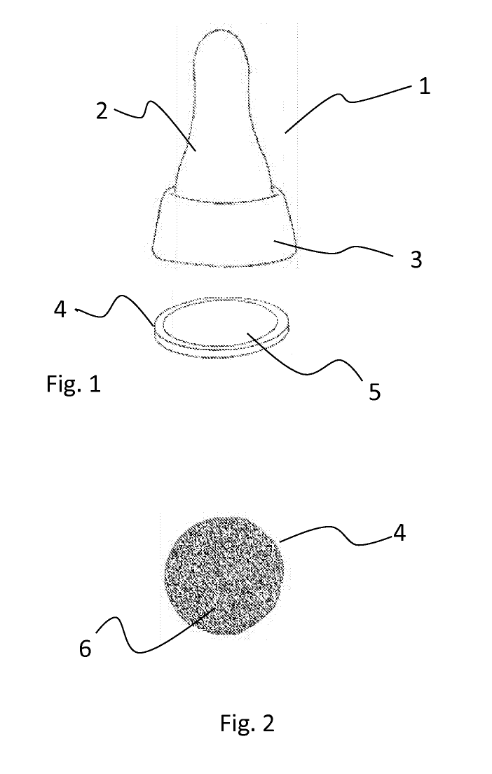

The stamp illustrated in FIG. 1 is a hand-held stamp 1 which includes a handle 2 and a stamping block 3 having a stamping surface of rubber or like material for receiving a flexible image transferring substrate 4. The exposed stamping surface of the block 3 is generally flat and the block may be formed integrally with the stamp, or be separable there from.

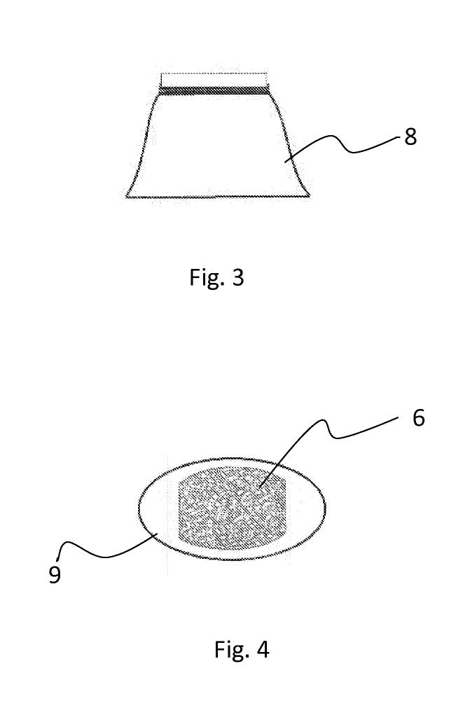

The image transferring substrate is impermeable and preferably comprises a piece of ethylene vinyl acetate (EVA) shaped and sized to be secured to the stamping surface of the stamping block 3. As will be seen from FIG. 2, the surface 6 of the substrate is textured. The substrate 4 may be one of a set of such substrates of the same or different shapes and sizes. Secured to one surface of the substrate is an adhesive pad 5 covered with a piece of removable masking tape. Alternative means for attaching the substrate to the stamping block may be adopted.

In an alternative arrangement, the substrates comprise perforated shapes formed in a single sheet of a polymer or copolymer such as EVA.

Substrates produced from impermeable textured polymers or copolymers other than EVA may be employed.

In use, colorant is selectively applied to the textured surface 6 of the substrate 4 either before or after the substrate is secured to the exposed stamping surface of the block 3 by, for example, a conventional fibrous tipped marker pen, a paint brush or similar applicator. More than one color may be applied to the substrate surface either randomly or as a pattern. In one embodiment the colorant is applied through suitably shaped stencils. Preferably, the ink or paint used is washable.

Once the substrate is secured to the stamping surface of the stamping block, the image created on the surface of the substrate can be transferred to any surface selected by the user, whether this is a sheet of drawing paper or some other medium.

Because of the textured impermeable nature of the EVA substrate the ink or paint applied to its surface remains wet for sufficient time to enable a user to apply ink or paint to the substrate surface to achieve a desired color blending or other effect. Experiments conducted by the Applicant have established that the surface remains wet for fifteen minutes or more. Corrections to the applied colorant can readily be made by removing some or all of the ink or paint using a soft cloth or the like. Inks or paints of different colors may be applied to the same substrate surface. Transfer of the design to a sheet of paper or the like using the hand held stamp removes all or most of the colorant from the surface of the substrate.

The surface of the substrate may be patterned to enable colored shapes to be produced consistently and transferred to a sheet of paper or the like. Thus, grooves, indentations and/or ridges in the shape of, for example, a flower or animal, may be formed in the substrate surface. Once colored these images can be replicated by transferring the colored images to, for example, a sheet of drawing paper. The grooves may be implanted into the substrate surface or may be created by the user employing a pointed relatively hard nib such as a ball point pen.

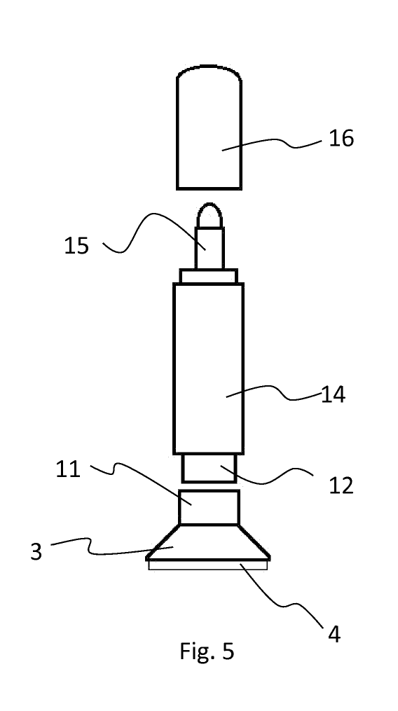

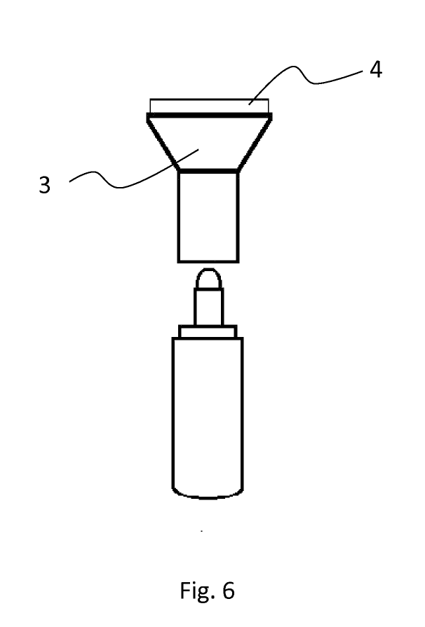

In an alternative embodiment of the invention illustrated in FIGS. 3 and 4, the stamp comprises a cup-shaped body 8 which can be gripped by a user of the stamp when transferring colored images to a chosen surface. The stamping surface 9 is shown as being generally oval, but other shaped surfaces may be employed. The stamping surface may be permanently attached to the body 8 or may be detachable there from. Thus, the stamping surface 9 may comprise the external surface of a lid of the cup-shaped body. In this way spare substrates may be stored within the body 8.

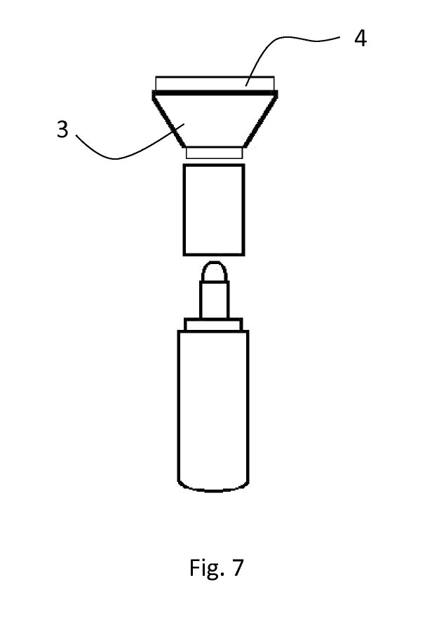

In the embodiments illustrated in FIGS. 5 to 7 the stamp and stamping block form parts of or are connectable to a marker pen. In FIG. 5, the stamping block 3 has a hollowed end 11 which locates over a complementary shaped projection 12 of a marker pen 14 having a fluid absorbent nib 15. The nib 15 is covered when not in use by a cap 16. In the embodiments of FIGS. 6 and 7 the stamping block 3 forms part of the cap 16 of the marker pen. In FIG. 6 the stamping block forms part of the cap, and in FIG. 7 is separable there from.

A coloring set in accordance with this invention may comprise a stamp as described, a plurality of polymeric substrates, a set of marker pens and a plurality of stencils.

More than one substrate may be applied to the surface of the stamping surface 4. Thus, a plurality of relatively small substrates of the same shape or of different shapes may be simultaneously attached to the stamping surface and then separately colored. These shapes may comprise, for example, geometric shapes such as squares, circles, stars and rectangles; or reflected images of letters of the alphabet; or flower shapes; or indeed any other suitable shapes. Once colored, dots or glitter particles or the like may be dispersed over the substrate surface for transfer with the image onto any required surface.

It will be appreciated that the foregoing is merely exemplary of stamping apparatus for transferring personalized colored patterns in accordance with the invention and that modifications may be made to the described apparatus without departing from the true scope of the invention. For example, the stamp need not be hand held. In such an arrangement, the stamp may be incorporated as part of a larger device which includes an operating mechanism capable of moving the substrate bearing stamping block into contact with an image receiving surface.

While various embodiments of the present invention have been described above, it should be understood that they have been presented by way of example only, and not of limitation Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A stamping apparatus for transferring a personalized colored image onto a selected surface, the apparatus comprising a stamp including a stamping surface and a flexible image bearing impermeable substrate of a polymer or copolymer attachable to the stamping surface, the image bearing surface of the substrate being textured.

2. The apparatus as claimed in claim 1 wherein the polymer or copolymer comprises ethylene vinyl acetate.

3. A stamping apparatus for transferring a personalized colored image onto a selected surface, the apparatus comprising a stamp having a stamping surface, an impermeable flexible substrate of a polymer or copolymer having an image bearing surface which is textured but otherwise plain, and a non image bearing surface, an attaching mechanism for attaching the non image bearing surface of the substrate to the stamping surface of the stamp, and an applying mechanism for applying a liquid colorant to the image bearing surface of the substrate.

4. The apparatus as claimed in claim 1 wherein the textured image bearing surface of the substrate is otherwise plain.

5. The apparatus as claimed in claim 3 wherein the polymer or copolymer is ethylene vinyl acetate.

6. A coloring set comprising the stamping apparatus of claim 1, wherein the flexible image bearing impermeable substrate of a polymer or copolymer is formed with a textured surface for selective or permanent attachment to the stamping surface, and further comprising:
a source for applying liquid colorant onto that surface of the substrate which will be exposed when the substrate is attached to the stamping surface.

7. A coloring set as claimed in claim 6 wherein the textured surface of the stamping surface is otherwise plain.

8. A coloring set as claimed in claim 6 wherein the stamp includes a handle.

9. The apparatus as claimed in claim 1 wherein the substrate comprises a flat sheet in the shape of a rectangle, square, circle, ellipse or other regular or irregular shape.

10. A coloring set as claimed in claim 6 wherein the substrate comprises a flat sheet in the shape of a rectangle, square, circle, ellipse or other regular or irregular shape.

11. The apparatus or a coloring set as claim 1 wherein the substrate comprises one of a set of such substrates.

12. The apparatus or a coloring set as claimed in claim 1 wherein one surface of the substrate is coated with an adhesive to enable it to be secured to the stamping surface.

13. The apparatus or a coloring set as claimed in claim 14 wherein the adhesive comprises an adhesive pad covered by a removable mask.

14. The apparatus or a coloring set as claimed in claim 1 wherein one surface of the substrate is scored, indented or ridged.

15. The apparatus as claimed in claim 1 wherein the source of colorant comprises a fibrous tipped marker pen.

16. The apparatus as claimed in claim 3 wherein the liquid colorant applying means comprises a fibrous tipped marker pen.

17. A coloring set as claimed in claim 6 comprising a plurality of substrates and a plurality of fibrous tipped marker pens.

18. A coloring set as claimed in claim 6 further comprising at least one stencil.

19. A flexible image bearing impermeable substrate formed with a textured surface for attachment to a stamping surface of a stamp, wherein the substrate comprises ethylene vinyl acetate.
